(19) United States
(12) Patent Application Publication
(10) Pub. No.: US 2003/0036315 A1
(43) Pub. Date: Feb. 20, 2003

(54) High density connector

(76) Inventors: Harjinder Dulai, Unionville (CA); En-Ming Chen, Markham (CA); Colin Szeto, North York (CA)

Correspondence Address: VEDDER PRICE KAUFMAN & KAMMHOLZ, 222 N. LASALLE STREET, CHICAGO, IL, 60601, US

(21) Appl. No.: 10/263,303

(22) Filed: Oct. 2, 2002

Related U.S. Application Data
(63) Continuation of application No. 09/651,154, filed on Aug. 30, 2000.

(51) Int. Cl. H01R 13/64

(52) U.S. Cl. 439/680

(57) ABSTRACT

The high density connector is primarily for use on a circuit board and in conjunction with a predetermined connector opening in an equipment housing for the circuit board. A socket housing has a substantially rectangular configuration and has a plurality of socket elements in a predetermined configuration in a first face of the socket housing. Each of the socket elements has an electrical lead extending from the socket housing, the electrical leads being electrically connected to the circuit board. The socket housing is mounted in the equipment housing such that the first face of the socket housing is aligned in the predetermined opening of the equipment housing. The leads are connected to a plurality of terminals on a circuit board. The plurality of terminals has substantially the same configuration as the configuration of the socket elements in the first face of the socket housing. The electrical leads extend from a second face of the socket housing, the second face being in a first plane. The plurality of terminals lies in a second plane of the circuit board, the first plane being parallel to the second plane. The first face of the socket housing is in a third plane that is at a predetermined angle to the first plane and the second plane. The first face of the socket housing has an electrical shield that substantially surrounds and extends from the first face of the socket housing. The plurality of socket elements forms a substantially rectangular array of substantially equally spaced socket elements.

### FIELD OF THE INVENTION

The invention relates generally to high density connectors, and in particular to a high density connector for use on an expansion board in a computer type apparatus.

### BACKGROUND OF THE INVENTION

An expansion board is a printed circuit board that plugs into an expansion slot in a computer. The expansion board extends the computer's ability to control another type of peripheral device. All boards that plug into a personal computer's bus are expansion boards, such as display adapters, disk controllers and sound cards. The expansion boards plug into expansion slots in the mother board of the computer.

One end of an expansion board has connectors mounted thereon for receiving cables which connect the computer to the peripheral devices. Numerous types of connectors are known in the prior art. For example, keyboards typically use a five pin DIN connector, while the PS/2 connector uses a smaller six pin mini-DIN connector. The PS/2 connectors can be used either for a mouse or keyboard depending upon the design of the computer. DB connectors are widely used in communication and computer devices and come in 9, 15, 25, 37 and 50 pin sizes. The pins are arranged in either two or three rows on the connectors. A DB-9 connector is commonly used for the first serial port on a personal computer, which is typically connected to the mouse. A high density DB-15 connector is used for the VGA port on a personal computer and has 15 pins in the same shell as a 9 pins of the DB-9 connector.

Other types of connectors are the RCA phono connector used for composite video, BNC connectors used for video and networking applications, F connectors for NTSC TV signals, mini-phone connectors for equipment such as headphones and speakers, and DVI connectors for video applications.

Typically, the expansion board has a metal plate on one end with an elongated aperture through which the connectors extend. The metal plate is also utilized to attach the expansion board to the chassis of the personal computer. With the increase in complex circuitry and computer equipment, and with the desirability of smaller physical equipment cases for personal computers, there is a problem in providing enough space in the opening in the metal bracket that supports the expansion boards, that is, providing space for enough connectors having enough pins to connect the personal computer to peripheral devices.

Therefore, there is a need for high density connectors that can be used with expansion boards and that fit in the available openings in the support brackets for the expansion boards.

### BRIEF DESCRIPTION OF THE DRAWINGS

The features of the present invention which are believed to be novel are set forth with particularity in the appended claims. The invention, together with further objects and advantages, may best be understood by reference to the following description taken in conjunction with the accompanying drawings, in the several figures of which like reference numerals identify like elements.

FIG. 1 is a rear view of the connectors on an expansion board in the prior art.

FIG. 2 depicts the expansion board with the connectors of the present invention.

FIG. 3 is a perspective view of the connector of the present invention.

FIG. 4 and FIG. 5 are, respectively, a front view and a side view of the socket of the connector of the present invention.

FIG. 6 and FIG. 7 are, respectively, a front view and a side view of the plug of the connector of the present invention.

FIG. 8 depicts a comparison of the connector of the present invention to a prior art connector.

### DETAILED DESCRIPTION OF A PREFERRED EMBODIMENT OF THE INVENTION

The high density connector of the present invention is primarily for use on a circuit board and in conjunction with a predetermined connector opening in an equipment housing for the circuit board. A socket housing has a substantially rectangular configuration and has a plurality of socket elements in a first configuration in a first face of the socket housing. Each of the socket elements has an electrical lead extending from the socket housing, the electrical leads being electrically connected to the circuit board.

The socket housing is mounted in the equipment housing such that the first face of the socket housing is aligned in the predetermined opening of the equipment housing. The leads are connected to a plurality of terminals on a circuit board. The plurality of terminals has a second configuration, substantially similar to the configuration of the socket elements in the first face of the socket housing. The electrical leads extend from a second face of the socket housing, the second face being in a first plane. The plurality of terminals lie in a second plane of the circuit board, the first plane being parallel to the second plane. The first face of the socket housing is in a third plane that is at a predetermined angle to the first plane. In one embodiment the first face of the socket housing is at a substantially right angle to the second face of the socket housing.

The first face of the socket housing has an electrical shield that substantially surrounds and extends from the first face of the socket housing. In one embodiment of the present invention the plurality of socket elements form a substantially rectangular array of substantially equally spaced socket elements, wherein the first configuration provides the array of socket elements having at least five rows and six columns.

A plug, for use with the socket housing, has a plug housing that mates with the socket housing. The plug housing has a plurality of plug elements that engage the plurality of socket elements in the first face of the socket housing. The plug elements have a third configuration, substantially similar to the first configuration of the socket elements and the second configuration of the plurality of terminals. Each of the socket housing and plug housing has polarization structures defined by the first configuration and the second configuration such that only one orientation is permitted for the socket and plug housings to be mated.

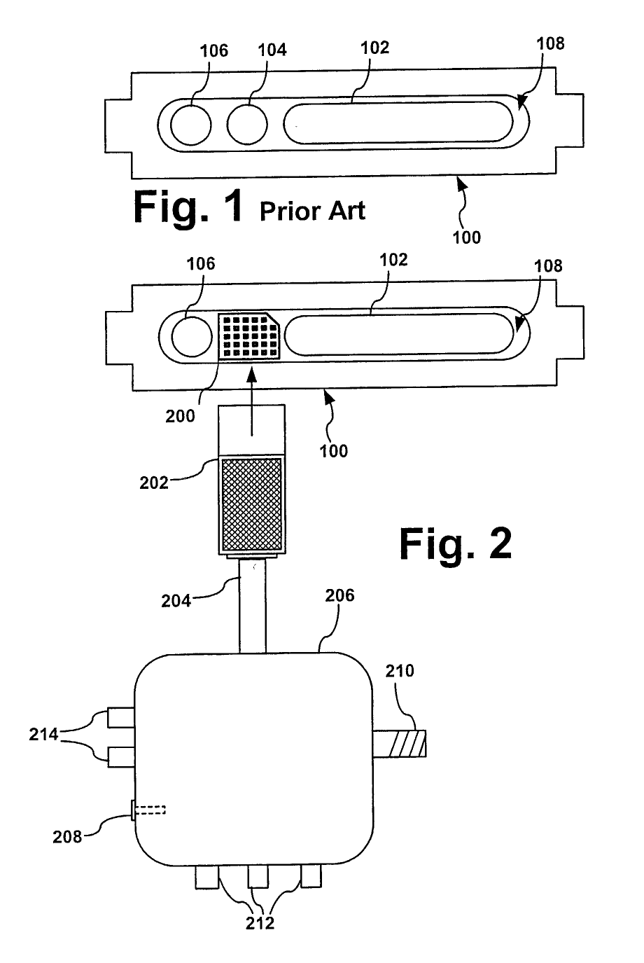

FIG. 1 schematically depicts a rear view of a prior art expansion board having a mounting plate 100 and a DVI connector 102, DIN connector 104 and a TV tuner connector 106. As shown in FIG. 1, the connectors 102, 104 and 106 substantially fill the available area in the elongated opening 108 of the bracket 100.

FIG. 2 depicts the connector of the present invention which has a socket housing 200 and a plug housing 202 which mates with the socket housing 200. The socket housing 200 fits substantially in the space that the prior art DIN connector 104 occupied in the opening 108 of the bracket 100. Whereas the DIN connector has only five or six pins, the connector according to the present invention and as shown in the FIG. 2 embodiment has 29 pins, yet fits into the space originally occupied by the DIN connector. The connector of the present invention is capable of carrying mixed signals, that is, video, audio and control signals. These signals can then be fed via the cable 204 to a distribution box 206 which has, for example, a mini phone connector 208, an F connector 210 for NTSC video, RCA phone connectors 212, for left and right audio and composite video, and other types of connectors 214 as may be required for various peripheral equipment.

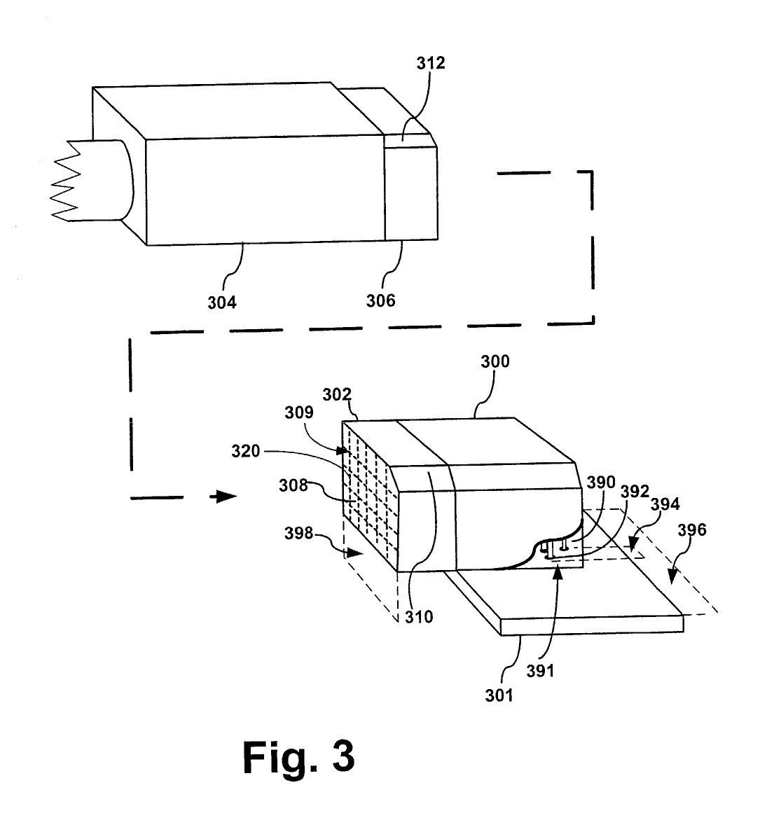

FIG. 3 shows in a perspective view the socket housing 300, of the present invention, which has a metal ground shield 302, also known as an electrical shield, which extends substantially around the housing 300. The socket housing 300 is connected to an expansion board or printed circuit board 301. As is well known in the art, electrical leads can extend from the bottom of the socket housing 300 through holes in the circuit board 301, the electrical leads then being wave soldered to the circuit board terminals. FIG. 3 also illustrates a plug housing 304, which has a metal shield 306 for grounding that mates with the metal shield 302 of the socket housing 300.

Polarization of the socket housing 300 and the plug housing 304 is effected by the structure 310 which mates with the corresponding structure 312 for the socket housing 300 and plug housing 304, respectively. In the embodiment depicted in FIG. 3, the structures 310 and 312 are a flattened corner-type configuration. Thereby, the socket housing 300 is provided with a first polarization structure defined by the flattened corner-type configuration, which provides for the orientation of the various socket elements 308. Furthermore, due to the structure 312, the plug housing 304 is provided with a second polarization structure defined by the flattened corner-type configuration, whereupon the first polarization structure requires second polarization structure, for the elements, 300 and 304, to be properly mated together. In other words, the first polarization structure of the socket housing 300 will only properly mate with a plug housing 304 having the second polarization structure.

Also depicted in FIG. 3 are electrical leads 390 of the socket housing 300, which lie in a first plane 394. The leads 390 extend from a second face 391 of the socket housing 300, wherein the second face 391 is defined as the socket housing face engaging the circuit board 301. These leads 390 are connected to respective terminals 392 in the circuit board 301. As shown in FIG. 3, the terminals 392 on the circuit board 301 lie in a second plane 396, which is parallel to the first plane 394. The terminals 392 are disposed in a second configuration, having a plurality of rows of terminals 392.

Furthermore, the second face 391 of the socket housing 300 also lies in the first plane 394. Leads 390 are connected to respective terminals 392 in the circuit board 301. As shown in FIG. 3, the terminals 392 on the circuit board 301 lie in a second plane 396, which is parallel to the first plane 394.

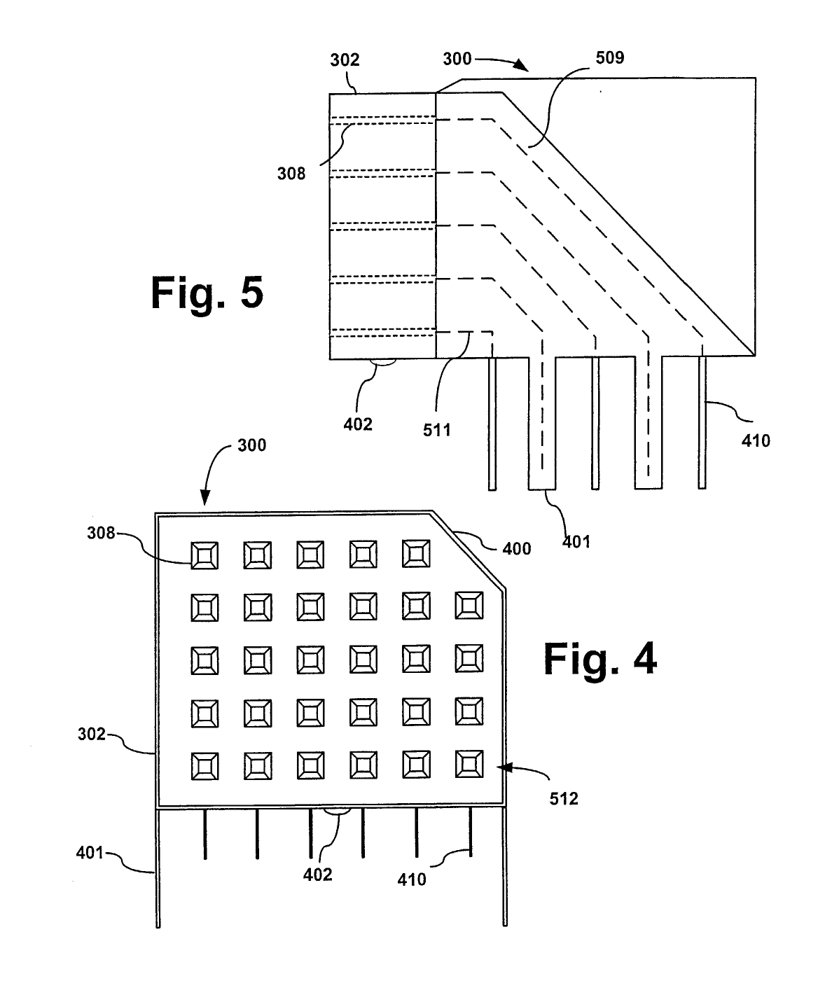

The socket housing 300 further comprises a plurality of socket elements disposed on a first face 309 of the socket housing 300, wherein the first face is defined as the socket housing face which engages the plug housing 304. A first configuration of the array of socket elements 308 in the socket housing 300, along the first face, is schematically depicted in FIG. 3. The dotted line 320 represents the divisional spacing of the socket elements 308, is the first configuration, as illustrated with reference to FIG. 4. These socket elements 308 are aligned with each other and lie in a third plane 398. In the embodiment of FIG. 3, the third plane is substantially perpendicular to the first plane 394, which corresponds to the second face 391 of the socket housing 300.

FIG. 4 is a front view of the socket housing 300 of the present invention and FIG. 5 is a side view of the socket housing 300 of the present invention. The metal shield 302 surrounds the socket elements 308 and extends along a side of the socket housing 300 to ground legs 401 which are soldered to ground terminals on the circuit board 301 depicted in FIG. 3. Each of the socket elements 308 is electrically connected via an electrical lead 509, also designated as element 390 in FIG. 3, to a corresponding electrical pin 410 that is soldered to a terminal on the circuit board 301.

The pins 410 are disposed in a fourth configuration that is substantially the same as the first configuration of the socket elements 308. More specifically, FIG. 4 illustrates socket elements 308 in the first configuration being aligned in a five by six rectangular array, with the exclusion of an element 308 for the shape of the corner 400 of the socket housing 300, therefore in the preferred embodiment, the pins 410 are also configured in a five by six rectangular array, excluding a sixth pin within a first row. The combination of pins 410 illustrated in FIGS. 4 and 5 illustrates the 6 columns of pins 410 corresponding to 6 columns of socket elements 308 (FIG. 4) and the 5 rows (3 rows visible, 2 not shown due to the ground legs 401 in FIG. 5) of socket elements 308. Furthermore, concurrently the terminals 392 of the expansion board, with which the pins 410 are connected, must also be configured substantially similar to the configuration of the socket elements 308, such as the five by six rectangular array, within the second configuration.

The socket housing 300 shows the socket elements 308 disposed within the first face and lying in the third plane 398 and the pins 410 disposed within the second plane 396 (see FIG. 3) parallel with the second face 391 of the socket housing 300, wherein the third plane 398 is disposed at a right angle to the plane of the pins 410, the second plane 396. However, it is within the teachings of the present invention that other angles, or even a parallel plane could be utilized for the array of socket elements 308 within the first face and the pins 410 parallel with the second face. Other configurations of the pins 410 and socket elements 308 relative to one another could be utilized with the present invention.

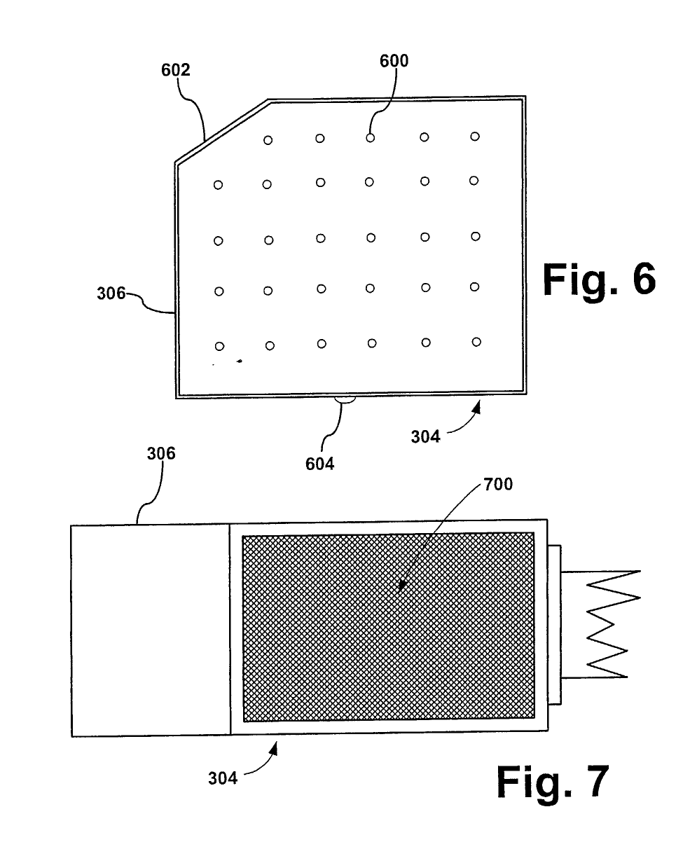

FIGS. 6 and 7 depict the corresponding plug housing 304 for the socket housing 300. The plug housing 304 has plug elements 600 which engage the socket elements 308 in the socket housing 300 when the plug housing 304 is mated with the socket housing 300. When the plug elements 600 engage the socket elements 308, the engagement occurs along the front face 309 of the socket housing 300. In order to properly mate the socket housing 300 and the plug housing 304, the plug elements 600 are within a third configuration, similar to the first configuration of the socket elements 308. As illustrated in FIG. 6, in one embodiment, the plug elements 600 are arranged in a five by six rectangular array, with the exception of an element 600 not disposed on the first row, first column position, to correspond with the indentation 312 of the plug housing 302, as seen in FIG. 3.

FIG. 7 shows the ground shield 306 of the plug 304. Also in FIG. 7, the plug 304 has an area 700 which aids in gripping the plug 304 for engaging and disengaging from the socket housing 300. For polarization a corner 602 of the plug 304 is cut off or flattened as shown in FIG. 6. Correspondingly, the corner 400 in FIG. 4 has the same configuration as the corner on the plug 602. The ground shield 306 on the plug 304 and the ground shield 302 on the socket housing 300 have corresponding mating configurations.

Also, as can be seen in FIG. 6 and FIG. 4, the plug housing 304 has a locking structure 604 which engages a mating locking structure 402 on the socket housing 300 when the plug housing 304 is engaged with the socket housing 300. In the embodiment depicted, the locking structures 402 and 602 are indentations in the metal shields 302 and 306, respectively, of the socket housing 300 and the plug housing 304.

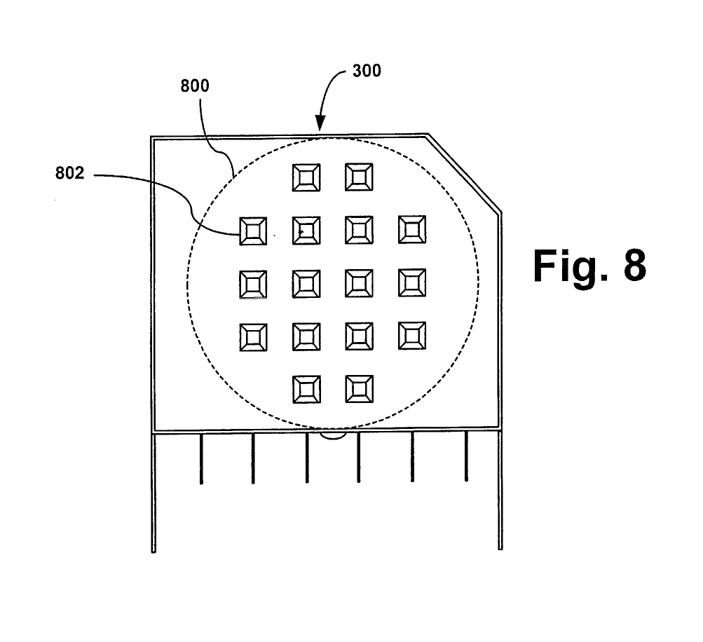

FIG. 8 depicts the advantage of the connector of the present invention over the prior art connectors. In particular, the prior art connector typically had a round shape 800 (such as used for the DIN connector) and it can be seen that complete use of this area (without a polarization configuration) has at a maximum 16 socket elements 802. However, by utilizing the configuration of the present invention, a total of 29 socket elements can be made available for carrying video, audio and control signals (see FIG. 4). Thus, the present invention fulfills the need in the prior art for providing high density connectors which can be used, in particular, on expansion boards. As shown in the disclosed embodiment, the connector of the present invention can provide five rows of socket elements (and corresponding plug elements) whereas other connective devices as known in the prior art, such as the DB connectors, can only provide three rows at the most.

The invention is not limited to the particular details of the apparatus depicted and other modifications and applications may be contemplated. For example, the connector may have various numbers of rows and columns of plug and socket elements. For example, the connector may have four or more rows of connector elements. Also, various structures and configurations may be used for mating the plug and socket portions of the connector of the present invention. Furthermore, different paths may be provided for connecting the socket elements to the electrical pins for conveying audio, video and/or control signals to the printed circuit board or expansion board. Certain other changes may be made in the above-described apparatus without departing from the true spirit and scope of the invention here involved. It is intended, therefore, that the subject matter of the above depiction shall be interpreted as illustrative and not in a limiting sense.

What is claimed is:

1. A high density connector for use on a circuit board and in conjunction with a predetermined substantially rectangular connector opening in an equipment housing for the circuit board, comprising:
a socket housing having a plurality of socket elements in a first configuration in a first face of the socket housing;
a plurality of electrical leads extending from the socket elements of the socket housing, the electrical leads being electrically connected to the circuit board; and
the socket housing being mounted in the equipment housing such that the first face of the socket housing is aligned in the predetermined opening of the equipment housing, wherein the socket housing has a flattened corner-type configuration defining a first polarization structure, wherein the first polarization structure provides for the first configuration including at least one row of socket elements having at least one less socket element than a plurality of remaining rows of socket elements and wherein the leads are also disposed in the first configuration including at least one row of leads having at least one less lead than a plurality of remaining rows of leads extending from a second face of the socket housing.

2. The high density connector according to claim 1, wherein the leads are connected to a plurality of terminals on the circuit board, the plurality of terminals being in a second configuration substantially similar to the first configuration of the socket elements in the first face of the socket housing, the second configuration including at least one row of terminals having at least one less terminal than the remaining rows of terminals.

3. The high density connector according to claim 2, wherein the plurality of terminals lie in the circuit board, and wherein the first face of the socket housing is at a predetermined angle with respect to the second face.

4. The high density connector according to claim 3, wherein the first face is at a substantially right angle to the second face of the socket housing.

5. The high density connector according to claim 1, wherein the electrical leads extend from a second face of the socket housing, and wherein the first face of the socket housing is at a predetermined angle with respect to the second face.

6. The high density connector according to claim 5, wherein the first face of the socket housing is at a substantially right angle to the second face of the socket housing.

7. The high density connector according to claim 6, wherein the first face of the socket housing has an electrical shield substantially surrounding and extending from the first face of the socket housing.

8. The high density connector according to claim 1, wherein the plurality of socket elements within the first configuration include four rows having six socket elements and a fifth row having five socket elements.

9. A high density connector system for use with an expansion board for computer equipment and in conjunction with a predetermined connector opening in a mounting plate that is attached to the expansion board, comprising:
a substantially rectangular socket housing having a plurality of socket elements in a first configuration, the socket housing having a flattened corner-type configuration defining a first polarization structure, wherein the first polarization structure provides for the first configuration including at least one row of socket elements having at least one less socket element than the remaining rows of socket elements;
each of the plurality of socket elements having an electrical lead extending from the socket housing, the electrical leads being electrically connected to the expansion board;
the socket housing being located on the expansion board such that a first face of the socket housing is aligned in the predetermined connector opening of the equipment housing;
a plug housing that mates with the socket housing; and
the plug housing having a plurality of plug elements that engage the plurality of socket elements in the first face of the socket housing, the plug elements being in a third configuration, substantially similar to the first configuration of the socket elements, the plug housing having the flattened corner type configuration defining a second polarization structure, wherein the second polarization structure provides for at least one row of plug elements having at least one less plug element than the remaining rows of plug elements, wherein the first and second polarization structures permit only one orientation of the plug and socket housings when mated.

10. The high density connector system according to claim 9, wherein the leads of the connector are connected to a plurality of terminals on the expansion board, the plurality of terminals being in a second configuration, substantially similar to the configuration of the socket elements in the first face of the socket housing, wherein the second configuration provides for at least one row of terminals having at least one less terminal than the remaining rows of terminals.

11. The high density connector system according to claim 10, wherein the electrical leads extend from a second face of the socket housing, wherein the plurality of terminals lie in the expansion board, and wherein the first face of the socket housing is at a predetermined angle with respect to the second face.

12. The high density connector system according to claim 11, wherein the first face is at a substantially right angle to the second face of the socket housing.

13. The high density connector system according to claim 9, wherein the first face of the socket housing has a first electrical shield substantially surrounding and extending from the first face of the socket housing, wherein the plug housing has a second electrical shield substantially surrounding the plug housing, and wherein the first electrical shield mates with the second electrical shield when the plug housing and socket housing are engaged.

15. The high density connector according to claim 9, wherein the plurality of socket elements forms a substantially rectangular array of substantially equally spaced socket elements.

16. The high density connector according to claim 15, wherein the plurality of socket elements is arranged in a number of rows that is greater than four.

17. The high density connector according to claim 15, wherein the array of socket elements has at least four rows.

18. The high density connector according to claim 15, wherein the array of socket elements has at least five rows and six columns.

19. A high density connector system for use with a circuit board and in conjunction with a substantially rectangular predetermined connector opening in an equipment housing for the circuit board, comprising:
a socket housing having a plurality of socket elements in a predetermined configuration in a first face of the socket housing, the socket housing having a flattened corner-type configuration defining a first polarization structure, wherein the first polarization structure provides for at least one row of socket elements having at least less socket element than the remaining rows of socket elements;
each of the plurality of socket elements having an electrical lead extending from the socket housing, the electrical leads being electrically connected to the circuit board, wherein the leads are connected to a plurality of terminals on the circuit board, the plurality of terminals being in a substantially same configuration as the configuration of the socket elements in the first face of the socket housing, providing an array of terminals wherein at least one row of terminals has at least one less terminal than the remaining rows of terminals;
the socket housing being mounted in the equipment housing such that the first face of the socket housing is aligned in the predetermined connector opening of the equipment housing;
a plug housing that mates with the socket housing; and
the plug housing having a plurality of plug elements that engage the plurality of socket elements in the first face of the socket housing, the plug elements being in a substantially same configuration as the configuration of the socket elements, the plug housing having the flattened corner-type configuration defining a second polarization structure, wherein the second polarization structure provides for at least one row of plug elements having at least one less plug element than the remaining rows of plug elements, wherein the first and second polarization structures permit only one orientation of the plug and socket housing when mated.

20. The high density connector system according to claim 19:
wherein the first face of the socket housing has a first electrical shield substantially surrounding and extending from the first face of the socket housing, wherein the plug housing has a second electrical shield substantially surrounding the plug housing, and wherein the first electrical shield mates with the second electrical shield when the plug housing and socket housing are engaged.
